(19) United States
(12) Patent Application Publication
(10) Pub. No.: US 2022/0051424 A1
(43) Pub. Date: Feb. 17, 2022

(54) OBJECT-RECOGNITION TRAINING

(71) Applicant: Opsis Health, Inc., Golden, CO (US)

(72) Inventors: Kevin P. Grundy, Emmett, ID (US); Jim Behrens, Golden, CO (US)

(21) Appl. No.: 17/402,259

(22) Filed: Aug. 13, 2021

Related U.S. Application Data
(60) Provisional application No. 63/065,454, filed on Aug. 13, 2020.

(51) Int. Cl. G06T 7/536; G06K 9/00; G06K 9/46; G06K 9/62; G06T 7/70

(52) U.S. Cl. CPC G06T 7/536; G06K 9/00201; G06T 7/70; G06K 9/6256; G06K 9/4661

(57) ABSTRACT

A sensor device generates images of an object from successive positional/illuminatory perspectives effected according to a predetermined or dynamically-generated recognition-training/object-modeling profile. The sensor device conveys the perspective images to an image processing engine and receives from the image processing engine, in response, data-capture guidance that informs next position/illumination for ensuing object-image generation.

### CROSS REFERENCE TO RELATED APPLICATIONS

This application hereby incorporates by reference and claims the benefit of U.S. provisional application No. 63/065,454 filed Aug. 13, 2020.

### DRAWINGS

The various embodiments disclosed herein are illustrated by way of example, and not by way of limitation, in the figures of the accompanying drawings and in which like reference numerals refer to similar elements and in which:

FIG. 1 illustrates an embodiment of an object-training recognition system having a perspective information generator coupled, via a digital communications network, to a back-end artificial-intelligence (or other image processing) engine;

FIG. 2 illustrates an exemplary sequence of sensor-device positions/orientations (effected by user or perspector conveyance of one or more sensors) at which respective sensor data sets (SD1-SDn; also referred to herein as object data sets) are captured;

FIG. 3 illustrates an embodiment of a perspective information generator in which a human operator conveys a handheld/portable sensor device over a mechanical guide;

FIG. 4 illustrates an exemplary graphical display (e.g., on a display of a sensor device) used to guide human-operator-conveyance of a sensor device between successive object perspectives;

FIG. 5 illustrates an exemplary data capture profile that may be implemented by the controller/programmed-processor of a user-conveyed sensor-device;

FIG. 6 illustrates an exemplary data capture profile that may be implemented by program code execution within the controller of a “perspector” appliance;

FIGS. 7 and 8 illustrate perspector embodiments having integrated and detachably-mounted sensor(s), respectively;

FIGS. 9 and 10 illustrate perspector embodiments having various alternative (and non-exhaustive) sensor/illuminator actuation schemes;

FIG. 11 illustrates a perspector embodiment incorporating a mechanical object manipulator that is actuated pursuant to a next position/next orientation profile to rotate and/or translate an object of interest to yield successive next positions/orientations with respect to fixed or actuated sensors/illuminators;

FIG. 12 illustrates a perspector embodiment that may be disassembled and compacted (folded, retracted, etc.) for portable/compact stowage; and

FIG. 13 illustrates a “fly-over” perspector embodiment having a fly-over arm rotatably attached to a base member to enable one or more sensors/illuminators integrated within the fly-over arm, or sensor device removably attached to the fly-over arm, to follow controlled, arc-trajectory with respect to an object of interest.

### DETAILED DESCRIPTION

In various embodiments herein, a sensor device generates images of an object from successive positional/illuminatory perspectives effected according to a predetermined or dynamically-generated recognition-training/object-modeling profile. In a number of embodiments, the sensor device conveys the perspective images to a cloud-based artificial-intelligence engine (i.e., accessed via Internet, intranet, wide-area network, local-area network, or other network or interconnection of computing devices) and receives from the AI engine, in response, data-capture guidance that informs next position/illumination (next perspective) for ensuing object-image generation. The sensor device (also referred to herein as “perspective information generator”) may be implemented, in alternative embodiments, by a (i) portable/handheld computing device having one or more integrated sensors and a user interface (e.g., smartphone, tablet, smart-camera or other “smart” sensor having an active pixel sensor (APS) imager, charge-coupled-device (CCD) imager, inertial measurement unit (IMU), illumination source(s), time-of-flight sensor, LIDAR, etc.) that is conveyed to successive positional perspectives and/or transitioned between different object-illumination settings by a human operator, or (ii) a “perspector” appliance having—together with a detachably mounted portable/handheld computing device and/or integrated sensor(s)/illuminator(s)/compute-controller—one or more actuators to convey sensor(s) and/or sensed-object to successive perspective-capture positions. In other embodiments, the perspector appliance may generate (or enable generation of) successive perspective images through dynamic adjustment of one or more integrated and/or detachably-mounted illumination sources, with or without mechanical actuation of sensors or sensed-object.

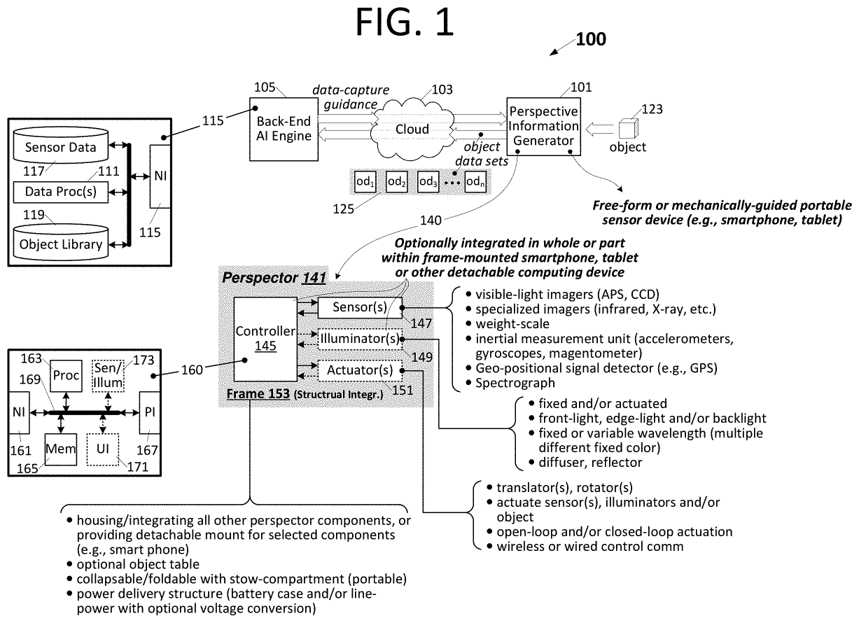

FIG. 1 illustrates an embodiment of an object-training recognition system 100 having a perspective information generator 101 coupled, via digital communications network (“cloud” 103), to a back-end AI engine 105. As shown in detail view 110, AI engine 105 may be implemented by one or more computing devices—e.g., one or more interconnected data processors 111, network interfaces 115 and storage devices, the latter to store, for example sensor data (117) and an object library (119)—co-located within a datacenter or distributed across multiple cloud-connected compute facilities, and the cloud interconnect 103 may be constituted (in whole or part) by the Internet, one or more wide area networks (WANs), local area networks (LANs) and/or any other practicable data communication network. In the depicted example, perspective information generator 101 is implemented, in a first embodiment, by a handheld (or otherwise portable) sensor device that is conveyed between object perspectives (i.e., physically moved relative to an object of interest 123 and/or exposed to varying illuminations with respect to object 123) by a human operator, and in a second embodiment by a perspector—an appliance that transitions an integrated and/or detachably mounted sensor device between successive object perspectives autonomously or in response to guidance from the AI engine. In either embodiment (user-wielded sensor device or perspector), information generator 101 produces “perspective information” useful for training an object recognition system implemented in whole or part by AI engine 105, the perspective information including, for example and without limitation, images of an object of interest obtained from different positional and/or illuminatory perspectives—moving (translating and/or rotating) an image-sensor, object-of-interest or both to vary the positional perspective, and/or varying an illumination setting (e.g., switching one or more illumination sources on or off, varying the output intensity/luminance, wavelength/color, transitioning between contrast-backgrounds, surrounds, diffusion structures, etc.) to change the object illumination (and thus the image-sensor perspective). Perspective information may be supplemented by (and deemed to include) various object-characterizing information (e.g., gravitational weight of object 123, object geo-positional information, spectroscopic information, etc.) and/or metadata inferred, observed or otherwise perceived with respect to object 123 (e.g., audible information emitted by object 123 and/or human observer naming or otherwise characterizing object 123; bar code, Quick Response (QR) code or the like adhered to or associated with object 123, etc.). Yet other “perspective information may be synthesized from directly perceived perspective information, including object size/extent (e.g., synthesized by triangulating object metes and bounds from perspective and/or stereoscopic images), object components (e.g., divining two or more distinct objects within a group of objects, such as distinct nutritional substances (foods) on a shared platter) and so forth.

In the FIG. 1 embodiment, information generator 101 conveys perspective information to AI engine 105 in a sequence of object data sets 125—individual collections of data obtained from respective positional/illuminatory perspectives—with the number of object data sets potentially varying with dynamically-determined object complexity. In one implementation, for example, a predetermined capture profile (or “preset”) is used to establish an initial number of object perspectives to be captured at relative positional offsets (e.g., image sensor circumnavigating the object of interest over a 180 degree arc to yield perspective information capture at nine (9) sensor positions progressively spaced at ˜20° from one another), with AI engine 105 and/or a local controller (within sensor device/perspector) updating that initial capture profile based, for example, on object complexity and/or training uncertainty. In the case of a platter of food containing multiple different food items, for example, AI engine 105 may determine that additional capture resolution (positional perspectives) along the sensor-traversed arc and/or additional circumnavigating arcs (e.g., the points of collection effectively forming a three-dimensional dome over the object of interest) are needed to build an effective object-recognition data record (e.g., for storage in object library 119) and/or object-modeling/volume-modeling data structure. The data capture profile (or training sequence) may additionally or alternatively be adjusted or otherwise supplemented in response to input from a human operator (i.e., an individual observing perspector operation or wielding a handheld sensor device), for example, supplying information via the perspector/sensor-device user-interface (touchscreen, keypad, microphone/voice, imager/gesture-facial expression, etc.) to establish an initial capture profile or adjust an initial profile. As a specific example, an image of the object of interest (which may include multiple distinct objects as in a platter of food) may be presented on a display (e.g., graphical user interface) of the sensor-device or perspector with a prompt for the user to draw or adjust (through touchscreen or other input) a bounding outline (rectangular box, circle/ellipse, polygon or amorphous shape) that encompasses the object of interest, including splitting the bounding outline into multiple outlines that encompass distinct objects within an imager field-of-view (FOV). The user supplied/adjusted bounding outline(s) may then be input to local or remote processing units (i.e., cloud-based AI engine) for purposes of adjusting/revising an initial data capture profile and/or generating the initial data capture profile.

In an embodiment shown in FIG. 1 detail view 140, perspector 141 includes a controller 145 together with one or more sensors 147 and, optionally, one or more illuminators 149, one or more actuators 151 and frame 153, the latter effecting a structural integration of the controller, sensor(s), illuminator(s) and/or actuator(s). The sensors may be integrated in whole or part within a detachably-mounted-to-frame “smart” device (e.g., smartphone, tablet, or other detachable computing device having on-board sensors) and, conversely, may be integrated in whole or part within (e.g., housed within or attached to) one or more components of the perspector frame. As in the case of a user-wielded portable sensor device (i.e., implementation of system 100 sans perspector), the sensors may include various visible-light imagers (e.g., APS, CCD), specialized imagers (infrared, X-ray, time-of-flight/distance including LIDAR, etc.), inertial-measurement sensors (e.g., accelerometers, gyroscopes, magnetometers as may be implemented, for example, in a 9-axis inertial measurement unit (IMU)), positional encoders, interferometers, luminance/light-intensity measuring elements, proximity sensors, auditory sensors, geo-positional signal detector (e.g., for detecting/receiving signals from global-positioning-system (GPS) satellites), gravitational-weight sensor, spectrograph and/or any other practicable sensor capable of generating information useful for object recognition/modeling. Optional illuminators 149 may include fixed and/or actuated light sources capable of front-lighting, edge-lighting, back-lighting or otherwise lighting an object of interest. One or more illuminators may emit light at different wavelength (e.g., different color within the visible-light spectrum) than other illuminator(s) and/or the wavelength of light emitted by one or more illuminators may vary in response to color-control/wavelength-control signal(s) from controller 145. Illuminator(s) may be supplemented (and deemed to include) various light-modifying structures (e.g., refractors, reflectors, diffusers, prisms, contrast-backgrounds, etc.). Illuminators (including light-modifying structures) may be implemented in whole or part within a detachably mounted sensor device (e.g., source of flash or continuous light integrated within a smartphone, tablet or the like) and/or integrated within the frame 153 or actuator components (or stand-alone components) of the perspector 141.

Still referring to perspector 141 (FIG. 1), optional actuators 151 may include any mechanism(s) capable of moving (translating and/or rotating) a sensor, illuminator, and/or object to enable varied visual perspectives, including motorized actuators powered by electrical potential (line power or battery), gravitational/kinetic potential (e.g., supplied by a user by spring-loading, fluid-compression, mass-lifting etc.) or any other practicable source of energy for powering mechanical actuation. The actuators themselves may effect linear translation, axial rotation, radial revolution, circumnavigation or any other motion of sensor and/or object useful for achieving varied perspective views. Actuator control signals (i.e., to trigger motion start/stop and/or control actuation speed, direction, velocity, acceleration, digital movement resolution, etc.) may be transmitted from controller 145 to actuator(s) 151 via wired or wireless interfaces (the latter including, for example and without limitation, communication via various radio-frequency standards such as Bluetooth, Near-field Communication (NRC), Wi-Fi, etc.) with the signaling media (wire, over-air) and/or communication protocol varying from actuator to actuator. The control signals may trigger open-loop or closed-loop actuation/motion, in the latter case with one or more positional sensors (e.g., rotary or linear positional-encoders—absolute or relative—interferometers, proximity sensors, etc.) providing feedback for closed-loop actuator control.

Perspector frame 153 (or chassis or housing or other component-interconnect structure) may be implemented by one or more removably-attached and/or integrally formed structural members—including one or more structural members (or groups of structural members) lacking attachment to one or more other structural members—capable of integrating, housing, and/or providing mounts or attach points for other perspector components (e.g., sensors, illuminators, actuators). In a number of embodiments, frame 153 includes a platform or table onto which the object of interest is to be placed (such “object table” being subject to translation in one two or three dimensions, and/or axial/radial rotation), including a platform having a degree of transparency to permit backlighting (i.e., from one or more illumination sources), installation of distinct and possibly non-attached sets of such structural members (e.g., swappable backgrounds or light filters of different color, reflectivity etc.), stowage compartments for compact fold-away storage footprint, power-delivery components (e.g., for connection to line power and/or insertion of removable electric batteries).

Still referring to perspector 141 of FIG. 1, controller 145 may be implemented by a variety of computing architectures and, as shown in detail view 160, may include one or more network interfaces 161 (e.g., for communicating with AI engine 105 via interconnect cloud 103), processors 163, memory components 165, and peripheral interfaces (“PI” to provide, for example, wired or wireless communications with respect to sensors 147, illuminators 149 and/or actuators 151) coupled to one another by any practicable interconnect structures (illustrated conceptually by bus 169, but may include various distinct signaling paths between depicted components). Controller 145 may also include a user interface (e.g., graphical-user-interface (GUI) display, virtual and/or physical keypad such as a touchscreen, microphone, speaker, haptic devices, etc.) and/or one or more integrated sensors and/or illumination elements 173 (e.g., light-emitting diode (LED) or other light-producing components). As discussed above, controller 145 wirelessly or conductively issues control signals to sensors 147 as necessary to trigger/initiate sensing operations and/or control sensor operation. In the case of APS imagers, for example, controller 145 may issue control signals to vary effective imager resolution from image to image (deemed a form of perspective variance for at least some embodiments herein), exchanging lower resolution for higher intensity or vice-versa through photocharge binning and/or pixel-readout-signal combination (charge binning, voltage binning, etc.). In a number of embodiments, controller 145 directly receives sensor output (e.g., pixel-value constituents of digital images, IMU output, GPS values, object-weight values, etc.), optionally performs sensor-data processing (e.g., finishing/enhancing digital images or otherwise conditioning sensor output signals) before outputting the sensor data (in the form of aforementioned object data sets 125) via network interface 161 to cloud-based AI engine 105. In other embodiments, one or more sensors may output sensor data in whole or part directly to the AI engine (e.g., through a network interface) rather than via controller 145.

As with sensors 147, controller 145 may issue control signals wirelessly or via wired control-signal conductors to one or more illuminators 149 (e.g., to switch illumination elements on/off, control illumination intensity, wavelength, etc.) and/or actuators 151 and may optionally receive status and/or handshaking information in return (e.g., positional feedback in the case of closed-loop motion control). Though depicted in the example 160 as a consolidated unit, controller 145 or any components thereof may be distributed among other perspector components. For example, one or more of processors 163 (and/or memories 165) shown in detail view 160 may be integrated within or disposed in proximity to (or be deemed part of) respective actuators 151—for example, to effectuate closed-loop motion (e.g., controlling motion profile, positional destination, etc.). Also, as discussed above, controller 145 may be integrated with some or all of sensors 147 and/or illuminators 149 within a frame-mounted smartphone, tablet or other independently operable and perspector-detachable computing device.

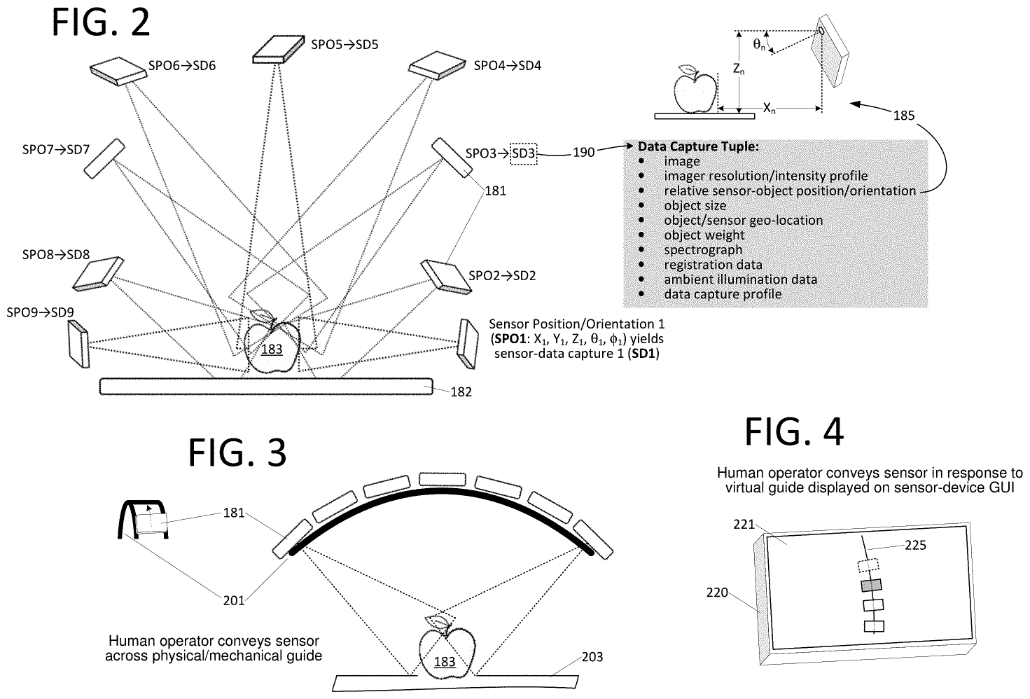

FIG. 2 illustrates an exemplary sequence of sensor-device positions/orientations (effected by user or perspector conveyance of one or more sensors) at which respective sensor data sets (SD1-SDn; also referred to herein as object data sets) are captured. In the depicted example, a sensor device 181 is implemented (at least in part) by a smartphone having an integrated camera (e.g., APS imager) and luminance-intensity meter, as well as an IMU capable of tracking sensor device position in three-dimensional (3D) space—a position expressed, in this example, by Cartesian coordinates of the camera aperture relative to a predetermined point (e.g., ‘x’, ‘y’ and ‘z’ distances from camera aperture to center-point of object platform 182, edge of object of interest 183, etc.) together with angular pitch and roll coordinates (i.e., θ and ϕ, respectively, with θ being, for example, the angle between an axis normal to the camera aperture and Cartesian axis ‘x’, and ϕ being the angle between the camera-normal axis and the ‘y’ Cartesian axis—‘ϕ’ and ‘y’ being normal to and thus unshown in the 2D detail view at 185). In other embodiments, particularly those having two or more off-axis imagers (e.g., stereoscopic imagers), a yaw coordinate/scalar (i.e., representing/indicating angular rotation about an axis normal to the aperture-surface of the sensor device) may be recorded within the sensor data set. In the FIG. 2 embodiment, each sensor-device position/orientation (SPO) refers to a relative attitude of one or more sensors with respect to the object of interest (183) and thus may be effected by repositioning/reorienting sensor device 181, object 183, or both. Also, absent explicit or contextually-clear distinction herein between angular orientation of sensor device 181 (e.g., θ and/or ϕ angular adjustment) and Cartesian (or polar-coordinate) position of sensor device 181, sensor “position” (or sensor-device position) should be understood to encompass both angular orientation and 3D location (Cartesian disposition of the subject sensor(s)/sensor-device. Further, while the object of interest (183) is depicted as a relatively small object in FIG. 2 and embodiments and examples discussed below (i.e., a food item and more specifically an apple), the object of interest may in all cases be substantially larger (e.g., human being, automobile, building or other large-scale mechanical construct) or smaller than object 183, with perspector component dimensions and/or structure adjusted accordingly.

In the FIG. 2 example, the sensor data set generated at each sensor-device position/orientation (SPO) is constituted by a data capture tuple 190 (i.e., multiple distinct metrics combined in a data structure) that includes, for example and without limitation, image data (array of pixel values), imager resolution/intensity profile at which the image was captured, relative sensor-object orientation (e.g., coordinates x, y, z, ϕ, θ as discussed above, including possible yaw angle), object weight, spectrographic information, speeds/velocities/accelerations, ambient illumination information (e.g., as sensed by a luminance/intensity meter and/or based on pixel intensity values in the captured image). The data capture tuple may also include information synthesized from data capture at one or more sensor positions/orientations (e.g., object size as determined, for example, by triangulating/extrapolating object extents from stereoscopic image capture at a given SPO, image capture at different sensor-device positions/orientations, and/or direct sensor-to-object distance measurement using, for example, a time-of-flight image sensor, LIDAR sensor, proximity sensor, etc.) as well as information encoded within one or more features of the object itself (e.g., barcode or QR code) and information supplied as part of the information capture guidance (e.g., data capture profile supplied by cloud-based AI engine). More generally, any information that may be obtained, inferred, deduced, synthesized or otherwise generated with respect to the object of interest may recorded within the data capture tuple and thus within the object data set to be returned to the AI engine.

FIG. 3 illustrates an embodiment of a perspective information generator in which a human operator conveys a handheld/portable sensor device 181 over a mechanical guide 201. In the example shown, mechanical guide 201 is constituted by a track that arcs over a surface of interest 203 (at which object of interest 183 is disposed) to enable generation of positionally-varied perspective images of the object of interest (i.e., within an imaging sensor of sensor device 181) as the sensor device is conveyed (slid) along the track. In a number of embodiments, sensor device 181 is moved relatively free-form with respect to mechanical guide 201 (e.g., track)—for example, with the exact overlay of the sensor device onto the track (of mechanical guide 201) being uncontrolled, and in other embodiments, the offset between rails of the track may be adjustable to engage edges of the sensor device and thus limit positional variance of the sensor device outside the desired trajectory. In yet other embodiments, a carriage (not specifically shown) to which the sensor device may be detachably mounted (and/or in which one or more sensors are integrated) is securely or removably mounted to the guide/track so that the sensor device traverses a completely controlled arc as a human operator moves the carriage from one end of the guide to the other. In yet other embodiments, mechanical guide 201 may be implemented by a radial member (e.g., spoke or rod to which the sensor device is detachably mounted and/or that integrates one or more sensors) that enables motion of the sensor device in a 3D sphere or hemisphere with controlled distancing and/or sensor orientation with respect to object of interest 183. More generally, any practicable mechanical guide—with or without integrated sensors—may be used to implement a perspective information generator in whole or part, potentially providing a more accurate spatial reference information (e.g., relative position of sensor and object) than a handheld sensor device conveyed without mechanical guide.

Referring to FIGS. 3 and 4, in one embodiment, a controller within a sensor device 220 (which may implement any of the sensor devices discussed above) executes program code to guide human-operator-conveyance of the sensor device from one data capture point (SPO) to the next (e.g., and thus a sequence of points forming a motion profile or path)—providing such instruction via a user interface 221 of the sensor device. In the FIG. 4 example, for instance, the executed program code illustrates a virtual path 225 (e.g., on a GUI of sensor device) corresponding to the physical path along which the user is to convey the sensor device (such conveyance occurring with or without aid of the FIG. 3 mechanical guide), thereby guiding user conveyance of the sensor device along a desired data capture path (which may include multiple paths/vectors defining a hemisphere or dome or other virtual surface with respect to the object of interest).

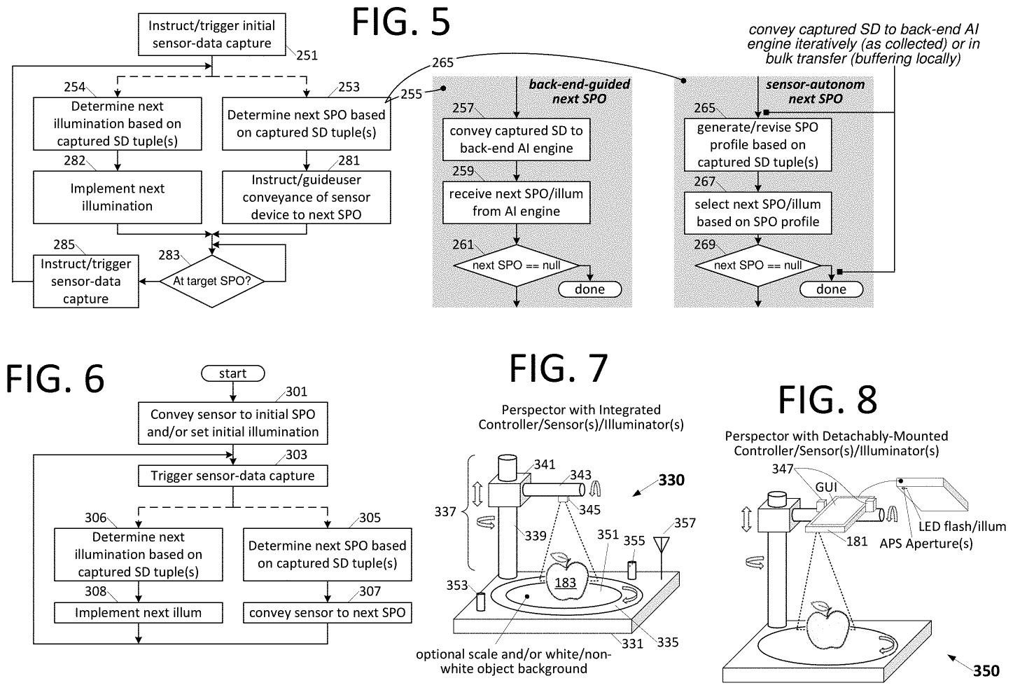

FIG. 5 illustrates an exemplary data capture profile that may be implemented by the controller/programmed-processor of a user-conveyed sensor-device (i.e., through program code execution and user-interaction via sensor-device UI). Starting at 251, the controller triggers (or instructs a user to trigger) sensor data capture at an initial perspective—that is, at an initial position (including a given orientation) and illumination setting—and then determines the next data-capture perspective (position and/or illumination) based on the captured data tuple as shown at 253 and 254. More specifically, in a back-end-guided implementation 255 (e.g., cloud-based AI engine provides or supplements next-perspective guidance), the controller conveys the captured data tuple (e.g., as an object data set) to the AI engine at 257, and then receives the next sensor position/orientation (SPO) and/or illumination setting from the AI engine at 259, deeming the overall data capture to be complete upon receiving a null-valued next-SPO (or other indication of completeness) from the AI engine (261). In a sensor-device-autonomous data capture implementation 265, the sensor-device controller itself generates the next-position/illumination information, generating or revising an SPO/illumination profile (i.e., planned positions/orientations at which respective data-capture is to occur) based on the data-capture tuple at 265 and then selecting (implementing/effecting) the next SPO/illumination at 267 until the profile is completed (e.g., null-valued next-SPO as shown at 269). In such sensor-autonomous implementations, captured data tuples may be conveyed to the back-end AI engine iteratively (e.g., as collected) or in a bulk transfer, buffering captured data (object data sets) within the controller memory or other storage until a predetermined volume of (or all) sensor-data tuples have been captured. In any case, after determining next SPO/illumination at 253/254, the sensor-device controller instructs or guides the user in conveyance of the sensor to a next position/orientation and/or implements the next illumination setting (e.g., changing the state of one or more illumination sources) as shown at 281 and 282, respectively. Upon detecting that the sensor device has reached the target SPO (i.e., affirmative determination at 283—and which target SPO may be the pre-existing SPO in cases where perspective is changed solely by revised illumination setting) the controller triggers (or instructs a user to trigger sensor-data capture at 285. Thereafter, the controller repeats the data capture loop (starting with determination of next SPO/illumination at 253/254) using one or more or all of data-tuples (sensor data sets/object data sets) captured prior to the point of loop iteration.

FIG. 6 illustrates an exemplary data capture profile that may be implemented by program code execution within the controller of a perspector appliance. Starting at 301, the controller effects an initial data-capture perspective by either commanding one or more actuators to convey sensor(s) to an initial position/orientation (initial SPO), commanding an initial illumination setting, or both. Thereafter, the controller triggers sensor-data capture at 303 (e.g., capturing one or more images, collecting IMU data, recording geo-position, object weight, etc. in accordance with available sensors) and then determines the next sensor position/orientation and/or illumination setting based on the captured data tuple (305, 306), implementing the next SPO (actuating/conveying sensor(s)) and/or illumination setting (307, 308), and then looping back to repeat the data capture at 303 (and then the next SPO/illumination determinations at 305, 306). As in the FIG. 5 embodiment, the next SPO/illumination—including determination that data capture is complete—may be determined with AI-engine guidance (perspector iteratively transmits captured data to AI engine via network interface) or autonomously within the perspector (with possible joint determination of next SPO/illumination through coordination between AI engine and perspector-controller). Also as in the FIG. 5 embodiment, the controller may determine the next data-capture perspective (position and/or illumination) based on all or any subset of captured data tuples at the point of next-SPO/next-illumination determination.

FIGS. 7 and 8 illustrate perspector embodiments 330 and 350 having integrated and detachably-mounted sensor(s), respectively. In each implementation, the perspector includes, as constituents/components of the perspector frame, a base 331 having a rotary-actuated object platform 335 (e.g., turntable), and a sensor tower 337 mounted to the base and having multiple actuated degrees of freedom to establish various sensor perspectives. More specifically, in the depicted examples, the sensor tower includes a rotatable stand 339, a vertically-actuated sensor-arm holder 341, and rotatably-actuated sensor arm 343, the latter housing or having integrated therein or thereon one or more sensors/illuminators 345 as shown in FIG. 7, or having one or more mounting/securing elements 347 to enable detachable-mounting of a sensor device (e.g., smartphone, tablet computing device, etc. having integrated controller/sensor/illuminator components as discussed above). In either the FIG. 7 or FIG. 8 embodiments (and all others having an object table herein), an optional weight-scale 351, backlighting and/or interchangeable background surface (to implement backgrounds of varying color, reflectivity, texture, etc.) may be implemented with respect to object table 335 (e.g., forming the object table or a portion thereof) and/or one or more additional illumination components, sensor components (353, 355) and/or communication components (e.g., RF antenna) may be disposed at various locations with respect to the perspector frame—the latter (RF antenna) shown conceptually as a projecting structure at 357, though various integrated-circuit-chip-embedded or otherwise low-profile antennas may be implemented. As demonstrated by the actuation (motion) arrows shown with respect to object platform 335 and sensor tower 337, sensors integrated within or detachably mounted to sensor arm 343 may be moved in 3D space with respect to an object disposed on platform 335—moving the relative positioning of object 183 and sensor (345 or sensors integrated within sensor device 181) from position to position per the next sensor position/orientation (SPO) control discussed in reference to FIG. 6 and capturing sensor data as each successive SPO is reached (with or without motion-stop at the SPO). Mechanisms for actuating object table 335 and/or components of sensor tower 337 may include any practicable actuation structures including, for example and without limitation, rotary or linear electric motors (i.e., direct-drive or gear-drive motors with the latter driving belts, sprockets, lead screws, ball screws, worm gears or any other practicable power transmission structure), pneumatic actuators, hydraulic actuators or any other practicable power source, including actuators driven by potential energy supplied by a human user (cocking spring, compressing piston, raising mass, etc.). Also, instead of or in addition to actuating one or more sensors, any or all depicted actuators may move an illumination source or sources, and any actuated sensor(s)/illumination source(s) may be supplemented by one or more sensors/illuminators disposed at other actuation points (e.g., on rotatable object platform 335) and/or at fixed locations with respect to the perspector frame (e.g., mounted on base 331 or other frame-attach point). As discussed above, actuation control signals may be supplied wirelessly (e.g., Bluetooth, NFC) or via wired connections according to any practicable protocol.

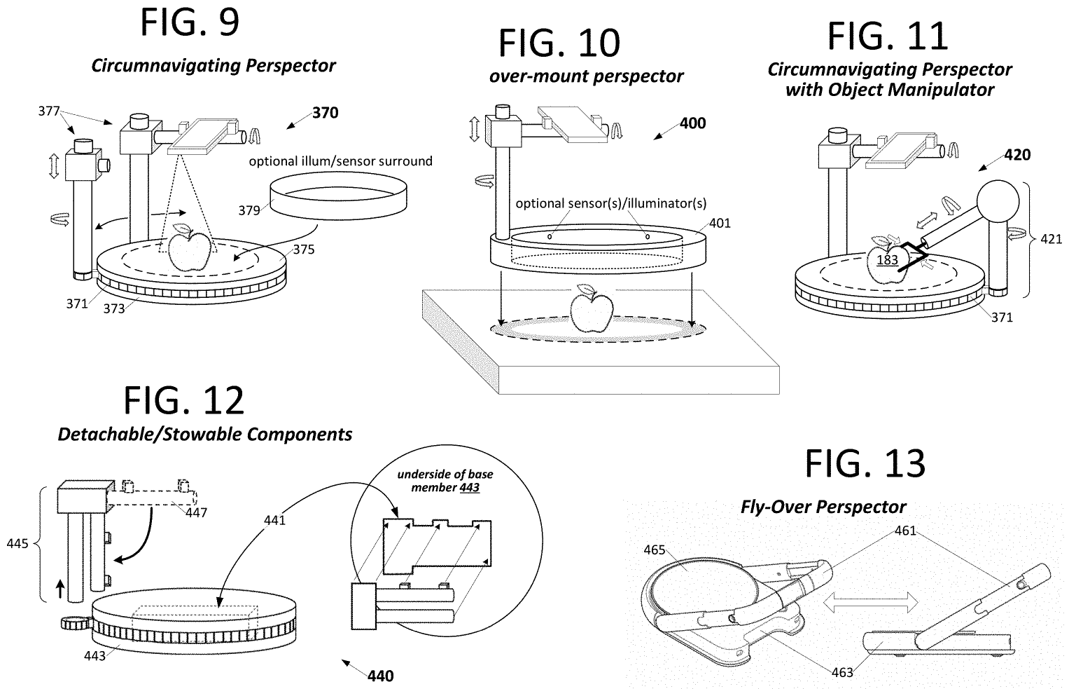

FIGS. 9 and 10 illustrate perspector embodiments having various alternative (and non-exhaustive) sensor/illuminator actuation schemes—each in the context of a detachably mounted sensor-device, though perspector-integrated sensors may be implemented (alternatively or additionally) in all cases. In the FIG. 9 “circumnavigating” perspector embodiment 370, a rotary carousel member 371 is implemented with respect to an otherwise fixed base 373 and object table 375. A sensor tower 377 (shown in alternative positions and, in the foreground instance, without the entirety of the sensor-bearing arm) may be implemented generally as shown and discussed with respect to FIGS. 7 and 8 and mounted to the carousel member to enable conveyance of the sensor arm around the object table (i.e., circumnavigating the object table and thus any object disposed thereon). As shown, an optional illuminator “surround” 379 (which may also or alternatively bear one or more sensors and/or one or more light-diffusion elements) may be disposed on (attached to and/or overlaid upon) object table 375—a construct that may be employed with respect to all perspector embodiments herein.

In the FIG. 10 embodiment, perspector 400 lacks an object table altogether and instead includes, as part of the perspector frame, a base member or stand that enables the perspector to be mounted over (or otherwise in strategic position with respect to) an object of interest—in this case a ring structure 401. In alternative embodiments, the over-mount structure may be implemented by a footed-stand (e.g., having one or more feet, optionally adjustable or having mechanical swivels or other mechanisms to enable disposition of the perspector on a non-planar surface) or any other practicable perspector support structure.

FIG. 11 illustrates a perspector embodiment 420 incorporating a mechanical object manipulator 421 that is actuated pursuant to a next position/next orientation profile as discussed in reference to FIG. 6—that is, manipulator rotating and/or translating object 183 to yield successive next positions/orientations with respect to fixed or actuated sensors/illuminators. Though depicted as a robotic arm (with grip) mounted to a circumnavigating member (e.g., rotating member 371 as discussed in reference to FIG. 9), any mechanical structure useful for repositioning/reorienting an object of interest may be implemented in alternative embodiments and mounted to any practicable point with respect to the perspector and/or object, including a manipulator disconnected from the primary frame of the perspector.

FIG. 12 illustrates a perspector embodiment 440 that may be disassembled and compacted (folded, retracted, etc.) by a user for portable/compact stowage. In the depicted example, a stowage compartment 441 is implemented within a base member 443 of the perspector frame, the compartment having a form-factor/outline that matches a folded instances of a removable sensor tower 445 (i.e., folding sensor-arm 447 down to yield a compact structure that fits snugly within the base-member compartment). While frame-member stowage is shown in accordance with the FIG. 9 circumnavigating perspector embodiment, stowable compartments, removable foldable/compactable frame members and/or stowed-component attach points may be implemented with respect to any and all perspector embodiments presented herein.

FIG. 13 illustrates yet another perspector embodiment 460, in this example having a “fly-over” arm 461 rotatably attached to a base member 463, thus enabling one or more sensors/illuminators integrated within the fly-over arm, or sensor device removably attached to the fly-over arm, to follow a semi-circular “fly-over” trajectory with respect to an object disposed on platform 465, the latter being subject to optional rotary actuation. In the depicted embodiment, fly-over arm 461 telescopes from a retracted fold-away position (i.e., for compact stowage) to one or more extended positions to enable a desired radial distance between integrated and/or detachably mounted sensors/illuminators and the object of interest. In one implementation, fly-over-arm extension is effected by a human user (making ready for object-recognition training for example by extracting the fly-over arm to one or more detent positions), and in others by an actuator or actuators to enable dynamic adjustment (including revised arm extension during a given sweep over the object of interest) of the radial distance between sensor/illuminator and object. The fly-over motion itself (i.e., rotation of fly-over arm 461 over object platform 465 and thus over an object of interest) may be motorized (e.g., electric motor) or actuated by user-stored potential energy (e.g., human operator moves fly-over arm from initial resting position to “cocked” position with respect to object platform, loading one or more springs, pneumatic/hydraulic piston, etc. that subsequently power the sweep of the arm back to the resting position).

In the foregoing description and in the accompanying drawings, specific terminology and drawing symbols have been set forth to provide a thorough understanding of the disclosed embodiments. In some instances, the terminology and symbols may imply specific details not required to practice those embodiments. For example, the various mechanical arrangements, sensor types, illumination schemes, actuators, controller/compute architectures, communication protocols, etc. are provided for purposes of example only—any practicable alternatives may be implemented in all cases. Communications between various sensor-device and/or perspector components may be implemented wirelessly and/or via wired connections (the latter implemented, for example, via multi-conductor buses or single signal lines). The term “coupled” is used herein to express a direct connection as well as a connection through one or more intervening circuits or structures. Integrated circuit device or register “programming” can include, for example and without limitation, loading a control value into a configuration register or other storage circuit within the integrated circuit device in response to a host instruction (and thus controlling an operational aspect of the device and/or establishing a device configuration) or through a one-time programming operation (e.g., blowing fuses within a configuration circuit during device production), and/or connecting one or more selected pins or other contact structures of the device to reference voltage lines (also referred to as strapping) to establish a particular device configuration or operational aspect of the device. The terms “exemplary” and “embodiment” are used to express an example, not a preference or requirement. Also, the terms “may” and “can” are used interchangeably to denote optional (permissible) subject matter. The absence of either term should not be construed as meaning that a given feature or technique is required.

Various modifications and changes can be made to the embodiments presented herein without departing from the broader spirit and scope of the disclosure. For example, features or aspects of any of the embodiments can be applied in combination with any other of the embodiments or in place of counterpart features or aspects thereof. Accordingly, the specification and drawings are to be regarded in an illustrative rather than a restrictive sense.

What is claimed is:

1. A method of training an object-recognition system, the method comprising:
generating, within a sensor device, one or more initial perspective images of an object;
transmitting the one or more initial perspective images of the object from the sensor device to a data processing system via a digital communications network;
after transmitting the one or more initial perspective images to the data processing system, receiving, from the data processing system via the digital communications network, guidance information indicative of one or more additional perspectives of the object from which one or more additional perspective images, respectively, are to be generated;
outputting informational signals to implement the one or more additional perspectives of the object;
generating the one or more additional perspective images of the object at the respective additional perspectives.

2. The method of claim 1 wherein generating the one or more initial perspective images of the object comprises generating a first image of the object while the sensor device is at a first disposition with respect to the object and wherein generating the one or more additional perspective images of the object comprises generating a second image of the object while the sensor device is at a second disposition with respect to the object, the second disposition being different from the first disposition.

3. The method of claim 2 wherein outputting informational signals to implement the one or more additional perspectives of the object comprises outputting informational signals to a user-visible display of the sensor device to illustrate thereon movement of the sensor device, to be effected by a human user, from the first disposition to the second disposition.

4. The method of claim 2 wherein outputting informational signals to implement the one or more additional perspectives of the object comprises outputting one or more actuator control signals to a first mechanical actuator to move the sensor device.

5. The method of claim 4 wherein outputting the one or more actuator control signals to the first mechanical actuator to move the sensor device comprises moving the sensor device from the first disposition with respect to the object to the second disposition with respect to the object.

6. The method of claim 4 wherein outputting informational signals to implement the one or more additional perspectives of the object further comprises outputting one or more additional actuator control signals a second mechanical actuator to move the object, and wherein outputting the one or more actuator control signals to the first mechanical actuator to move the sensor device and outputting the additional one or more actuator control signals to the second mechanical actuator to move the object collectively constitutes movement of the sensor device, with respect to the object, from the first disposition to the second disposition.

7. The method of claim 2 wherein outputting informational signals to implement the one or more additional perspectives of the object comprises outputting one or more actuator control signals to a mechanical actuator to move the object and wherein outputting the one or more actuator control signals to the mechanical actuator to move the object comprises moving the sensor device from the first disposition with respect to the object to the second disposition with respect to the object.

8. The method of claim 1 wherein outputting informational signals to implement the one or more additional perspectives of the object comprises outputting one or more control signals to effect mechanical actuation of a platform on which the object is disposed.

9. The method of claim 1 wherein generating the one or more initial perspective images of the object comprises generating a first image of the object while the object is subject to a first illumination setting and wherein generating the one or more additional perspective images of the object comprises generating a second image of the object while the object is subject to a second illumination setting.

10. The method of claim 9 wherein generating the first image of the object while the object is subject to the first illumination setting and generating the second image of the object while the object is subject to the second illumination setting comprises effecting the first illumination setting by driving one or more light-emitting elements to a first state and effecting the second illumination setting by driving one or more light-emitting elements to a second state.

11. The method of claim 10 wherein driving the one or more light-emitting elements to the first state comprises setting output intensity of a first one of the one or more lighting elements to a first level, and driving the one or more light-emitting elements to the second state comprises setting output intensity of the first one of the one or more lighting elements to a second level, different from the first level.

12. The method of claim 11 wherein setting output intensity of the first one of the one or more lighting elements to one of the first and second levels comprises switching off the first one of the one or more lighting elements.

13. The method of claim 1 wherein generating the one or more initial perspective images of the object comprises generating, within an image sensor of the sensor device, a visible-light image of the object.

14. The method of claim 1 further comprising capturing additional information with respect to the object and transmitting the additional information to the data processing system in association with the one or more initial perspective images of the object.

15. The method of claim 14 wherein the additional information comprises at least one of a resolution profile of an image sensor within the sensor device, gravitational-weight of the object, ambient illumination detected with respect to the object, information indicative of a geo-location of the object, spectrographic information with respect to the object, or registration information obtained from one or more data markings associated with the object.

16. An object-recognition trainer comprising:
a first sensor to generate one or more initial perspective images of an object and then generate one or more additional perspective images of the object from one or more additional perspectives, respectively; and
control circuitry to:
transmit the one or more initial perspective images of the object to a data processing system via a digital communications network and then receive, from the data processing system via the digital communications network, guidance information indicative of the one or more additional perspectives of the object from which the one or more additional perspective images are to be generated; and
output informational signals to implement the one or more additional perspectives of the object.

17. The object-recognition trainer of claim 16 further comprising a first actuator to enable change in relative positions of the object and first sensor.

18. The object-recognition trainer of claim 17 wherein the control circuitry to output informational signals to implement the one or more additional perspectives of the object comprises circuitry to output one or more control signals to the first actuator such that the first actuator moves the first sensor or the object to implement the one or more additional perspectives of the object.

19. The object-recognition trainer of claim 17 further comprising a second actuator to enable change in relative positions of the object and first sensor, the first and second actuators to move the first sensor and the object, respectively in response to the informational signals from the controller.

20. The object-recognition trainer of claim 16 further comprising a first illumination element to enable change in ambient illumination with respect to the object.

21. The object-recognition trainer of claim 20 wherein the control circuitry to output informational signals to implement the one or more additional perspectives of the object comprises circuitry to output one or more control signals to the first illumination element to implement the one or more additional perspectives of the object, at least in part, by changing the ambient illumination with respect to the object.

22. The object-recognition trainer of claim 21 wherein the circuitry to output the one or more control signals to implement the one or more additional perspectives comprises circuitry to transition the first illumination element from to a first light-emitting intensity state to a second light-emitting intensity.

23. The object-recognition trainer of claim 22 wherein at least one of the first and second light-emitting intensities corresponds to a shut-off state of the first illumination element.

24. The object-recognition trainer of claim 16 wherein the object-recognition trainer comprises a moveable frame member on which the first sensor is disposed.

25. The object-recognition trainer of claim 24 wherein the first sensor and control circuitry are constituent elements of a portable computing device detachably mounted to the moveable frame member.

26. The object-recognition trainer of claim 24 wherein the first sensor is integrated within the moveable frame member.

27. The object-recognition trainer of claim 24 further comprising a base structure to enable placement of the object-recognition trainer on a surface.

28. The object-recognition trainer of claim 27 wherein the base structure comprises an object platform on which the object may disposed to enable generation of the initial and additional perspective images.

29. The object-recognition trainer of claim 28 further comprising an actuator, responsive to the informational signals from the control circuitry, to move the moveable frame member and first sensor with respect to the object platform.

30. An object-recognition trainer comprising:
means for generating one or more initial perspective images of an object from one or more initial perspectives and, after generating the one or more initial perspective images, for generating one or more additional perspective images of the object from one or more additional perspectives, respectively; and
means for transmitting the one or more initial perspective images of the object to a data processing system via a digital communications network and then receiving, from the data processing system via the digital communications network, guidance information indicative of the one or more additional perspectives of the object from which the one or more additional perspective images are to be generated; and
means for implementing the one or more additional perspectives of the object.
